(19) United States
(12) Patent Application Publication
(10) Pub. No.: US 2026/0365506 A1
(43) Pub. Date: Nov. 19, 2026

(54) HYDROGEN-ENRICHED WATER DISPENSER

(71) Applicant: ANDY MARS TECHNOLOGY CO., LIMITED, Sai Ying Pun (HK)

(72) Inventor: An Di NI, Sai Ying Pun (HK)

(21) Appl. No.: 19/206,064

(22) Filed: May 13, 2025

(51) Int. Cl. B67D 1/00; B01F 23/237; B01F 23/45; B01F 25/00; B01F 35/83; B01F 101/00; B67D 1/08; B67D 1/12; B67D 1/16; C02F 1/68; C25B 9/63

(52) U.S. Cl. CPC B67D 1/0042; B01F 23/23764; B01F 23/45; B01F 25/1051; B01F 35/833; B67D 1/0014; B67D 1/0895; B67D 1/1281; B67D 1/16; C02F 1/68; C25B 9/63; B01F 2101/305; B67D 2210/00031; C02F 2307/10

(57) ABSTRACT

Disclosed is a hydrogen-enriched water dispenser, including a chassis and a water storage tank fixed to a top portion of the chassis, with a hydrogen production assembly and a hydrogen mixing assembly provided inside the chassis, a dispensing tray assembly provided at one side of the chassis, a water outlet pipe penetrating through and fixed to a bottom portion of the hydrogen mixing assembly, a water outlet end of the water outlet pipe extending above the dispensing tray assembly, and a water bottle seat fixed inside the water storage tank; and the hydrogen mixing assembly including a hydrogen mixing chamber and a partition, with the hydrogen mixing chamber communicating with the anode chamber, a vent pipe connected between the hydrogen mixing chamber and the cathode chamber, and the vent pipe having through-holes at its bottom portion and having one end extending to a bottom portion of the hydrogen mixing chamber.

### TECHNICAL FIELD

The present invention relates to the technical field of water dispensers, and in particular to a hydrogen-enriched water dispenser.

### BACKGROUND

Hydrogen-enriched water is produced by introducing hydrogen gas into water, allowing a portion of the hydrogen gas to dissolve in the water, thereby increasing the hydrogen content of the water to produce hydrogen-enriched water. In the prior art, hydrogen-enriched water dispensers often produce hydrogen gas through electrolysis of water, introduce the hydrogen gas into a hydrogen mixing chamber to mix with water for producing hydrogen-enriched water, and then discharge the produced hydrogen-enriched water. During this process, the introduction of hydrogen gas and the discharge of hydrogen-enriched water require electrical devices such as gas pumps and liquid pumps, which results in higher manufacturing costs of the dispensers. Additionally, the gas pressure within the hydrogen mixing chamber affects the dissolution amount of hydrogen gas. Therefore, existing hydrogen-enriched water dispensers often control the gas pressure in the hydrogen mixing chamber through production at a specific quantity. If a smaller amount of hydrogen-enriched water needs to be produced, more water must be electrolyzed, leading to lower efficiency. Furthermore, if the hydrogen-enriched water produced at a specific quantity is not consumed promptly, the dissolved hydrogen gas will gradually escape, causing a reduction in hydrogen gas content and resulting in waste.

### SUMMARY

An objective of the present invention is to provide a hydrogen-enriched water dispenser, so as to solve the problems of high manufacturing costs of existing hydrogen-enriched water dispensers and eliminate the restriction of production of hydrogen-enriched water at a specific quantity.

In order to achieve the above objective, the present invention provides the following technical solutions:
a hydrogen-enriched water dispenser, including a chassis and a water storage tank fixed to a top portion of the chassis, where a hydrogen production assembly and a hydrogen mixing assembly are provided inside the chassis, and a dispensing tray assembly is provided at one side of the chassis, where a water outlet pipe penetrates through and is fixed to a bottom portion of the hydrogen mixing assembly, a water outlet end of the water outlet pipe extending above the dispensing tray assembly, and a water bottle seat is fixed inside the water storage tank;
the hydrogen production assembly includes a hydrogen production tank and a T-shaped mounting frame installed inside the hydrogen production tank, where two sides of a vertical end of the mounting frame are respectively a cathode chamber and an anode chamber, electrolytic rods being installed on the mounting frame in both the cathode chamber and the anode chamber, and bottom ends of the two electrolytic rods being both higher than a bottom end of the mounting frame; and
the hydrogen mixing assembly includes a hydrogen mixing chamber disposed inside the chassis and a partition slidably disposed inside the hydrogen mixing chamber, where the hydrogen mixing chamber above the partition is in communication with a top portion of the anode chamber, and a vent pipe is connected between the hydrogen mixing chamber below the partition and a top portion of the cathode chamber, the vent pipe having one end extending to a bottom portion of the hydrogen mixing chamber and the vent pipe having a plurality of through-holes provided at a bottom portion thereof.

Optionally, a water supply pipe is connected between the water storage tank and the hydrogen production tank, the water supply pipe being provided with a flow control valve.

Optionally, a heating tank is fixed inside the chassis, where a top portion of the heating tank is in communication with the water storage tank, a cold water pipe and a hot water pipe penetrate through and are fixed to the water storage tank and the heating tank, respectively, and a water inlet pipe penetrates through and is fixed to one side of the hydrogen mixing chamber below the partition, a mixing valve being connected between the water inlet pipe and the cold water pipe and the hot water pipe, where the mixing valve includes a piston symmetrically provided with two water inlet channels, an outer side of the piston being provided with two spiral channels that are in communication with the two water inlet channels, respectively.

Optionally, two exhaust valves penetrate through and are fixed to one side of the chassis, where the two exhaust valves are both in communication with the hydrogen mixing chamber, and the two exhaust valves are respectively located on an upper side and a lower side of the partition.

Optionally, the water outlet pipe and the vent pipe are each provided with a check valve assembly, the check valve assembly including a fixing frame and a stop ring that are fixed to an inner wall of the water outlet pipe or the vent pipe, where a slide rod slidably penetrates through the fixing frame, a first spring being fixedly connected between a bottom end of the slide rod and the fixing frame, and a sealing block in a truncated cone structure being fixed to a top portion of the slide rod, where an outer wall of the sealing block is slidably engaged with an inner wall of the stop ring.

Optionally, two locking plates are symmetrically and slidably connected inside the hydrogen production tank, and a rotating handle is rotatably connected at one side of the hydrogen production tank, where a rotating rod is fixedly connected at one end of the rotating handle, a sliding shaft being fixedly installed at each of two ends of the rotating rod, and a sliding groove being provided at one side of each of the two locking plates, and the two sliding shafts being respectively slidably engaged within the two sliding grooves, a plurality of second springs are fixedly connected between the two locking plates and a middle portion of the hydrogen production tank, and a plurality of locking grooves slidably engaged with the two locking plates are formed on the chassis.

Optionally, the dispensing tray assembly includes a drip tray slidably connected inside the chassis and a filter screen fixed on the drip tray, two clamping plates for clamping a cup being symmetrically and slidably connected to a top portion of the filter screen.

Optionally, two support frames are symmetrically and rotatably connected to the chassis, top ends of the two support frames being both slidably connected to a bottom portion of the drip tray, and the top ends of the two support frames being both rotatably connected with first sliding frames, a worm rotatably penetrates through one side of the drip tray, and a double-headed screw is rotatably connected to the bottom portion of the drip tray, where the two first sliding frames are respectively threadedly connected to two ends of the double-headed screw, and a worm wheel is coaxially fixed on the double-headed screw, the worm wheel being in meshed connection with the worm.

Optionally, a lead screw is rotatably connected within the drip tray, the lead screw being threadedly connected with a second sliding frame and second sliding frame being slidably connected to the drip tray, two sliding posts are slidably connected to a top portion of the second sliding frame, guide grooves respectively slidably engaged with the two sliding posts are formed on the filter screen and the two guide grooves are provided to be inclined, and recesses are respectively formed on bottom portions of the two clamping plates, the two sliding posts respectively extending slidably into the two recesses.

Optionally, one end of the worm is fixedly connected with a handwheel, and a square post is slidably connected inside the worm, where a first gear and a second gear are respectively coaxially fixed at one end of the square post and one end of the lead screw, and a button is fixedly connected to the other end of the square post, a third spring being fixedly connected between the button and the worm.

Compared with the prior art, the present invention has the following beneficial effects:
(1) In the present invention, a vent pipe is provided. The cathode chamber of the hydrogen production assembly produces hydrogen gas. As the gas pressure increases, the hydrogen gas enters the hydrogen mixing chamber along the vent pipe, and the hydrogen gas emerges in the form of bubbles through a through-hole at a bottom portion of the vent pipe, thereby increasing the contact area between the hydrogen gas and water to accelerate dissolution and rapidly produce hydrogen-enriched water. Subsequently, the hydrogen gas accumulates above the water surface, causing the gas pressure in the hydrogen mixing chamber to increase. When the gas pressure in the hydrogen mixing chamber increases to a set value, continued introduction of hydrogen gas can push the hydrogen-enriched water to discharge it from a water outlet end of the water outlet pipe, thereby achieving on-demand production and dispensing of hydrogen-enriched water. Moreover, electrical devices such as gas pumps and liquid pumps are not required during the production process, resulting in lower manufacturing costs of the water dispenser.
(2) In the present invention, a partition is provided. Hydrogen gas produced by water electrolysis enters the hydrogen mixing chamber located below the partition via the vent pipe, while produced oxygen gas enters the hydrogen mixing chamber above the partition. When producing a small amount of hydrogen-enriched water, the gas occupies a larger space within the hydrogen mixing chamber. Oxygen gas and hydrogen gas on both upper and lower sides of the partition collectively fill the hydrogen mixing chamber and achieve gas pressure equilibrium. During the process of increasing the gas pressure in the hydrogen mixing chamber below the partition to the set value, oxygen gas can replace hydrogen gas to occupy a portion of the space, thereby reducing water consumption for electrolysis during small-scale production of hydrogen-enriched water and improving production efficiency of hydrogen-enriched water.
(3) In the present invention, a mixing valve is provided. The mixing valve may move upward and downward in a pipeline to control the opening and closing of a water inlet pipe. When two water inlet channels of the mixing valve are respectively in communication with a cold water pipe and a hot water pipe, the mixing valve may be rotated to adjust the sizes of communication ports between the two water inlet channels and the cold water pipe and hot water pipe. In this way, cold water from a water storage tank and hot water from a heating tank can be introduced at different ratios, and after passing through the spiral channels, the water is discharged from a bottom portion in a swirling manner, thereby uniformly mixing hot water and cold water to produce hydrogen-enriched water at different temperatures with consistent thermal distribution.
(4) In the present invention, a rotating handle and locking plates are provided. After prolonged use of electrolytic rods, impurities in water adhere to the electrolytic rod in the anode chamber, affecting contact between water and the electrolytic rod and consequently reducing the electrolysis rate. Therefore, by rotating the rotating handle to drive the rotating rod to rotate, sliding shafts at both ends of the rotating rod respectively drive the two locking plates to move toward a middle portion via two sliding grooves, and the hydrogen production tank can then be pulled out from the chassis, thereby facilitating replacement of the electrolytic rods, which offers simple operation and high efficiency.
(5) In the present invention, support frames are provided. Two clamping plates clamp the cup on the filter screen of the drip tray to prevent the cup from shaking when receiving hydrogen-enriched water. Then, by rotating the handwheel to drive the worm to rotate, the worm wheel drives the double-headed screw to rotate, which causes two first sliding frames to move outward, causing the two support frames to rotate outward, thereby pushing the drip tray upward, and thus bringing the cup on the drip tray closer to the water outlet end of the water outlet pipe. This, on the one hand, prevents splashing of hydrogen-enriched water, and on the other hand, prevents an excessive outflow distance of the hydrogen-enriched water, which would cause the dissolved hydrogen gas to escape, thereby ensuring the hydrogen content of the hydrogen-enriched water.
(6) In the present invention, a square post, a first gear, and a second gear are provided. When the two clamping plates clamp the cup, pressing the button causes the square post to slide within the worm, thereby driving the first gear to move below the second gear to engage the first gear and the second gear. Then, by rotating the worm, the square post is driven to rotate, transmitting motion through the first gear and second gear to rotate the lead screw, thereby moving the second sliding frame along the lead screw. Simultaneously, the two sliding posts slide along inclined guide grooves on the filter screen, such that the two sliding posts drive the two clamping plates to move toward the middle portion to clamp the cup. After clamping, releasing the button disengages the first gear and second gear under the action of the third spring. At this time, rotating the worm can only achieve vertical movement of the drip tray with the cup. This achieves a compact structure and simplified operation.

### BRIEF DESCRIPTION OF DRAWINGS

FIG. 1 is a perspective view of the present invention;

FIG. 2 is a first cross-sectional view of the present invention;

FIG. 3 is an enlarged view of portion A of FIG. 2;

FIG. 4 is a second cross-sectional view of the present invention;

FIG. 5 is a third cross-sectional view of the present invention;

FIG. 6 is a perspective view of the connection assembly of pipelines of the present invention;

FIG. 7 is a cross-sectional view of the connection assembly of the pipelines of the present invention;

FIG. 8 is a perspective view of a mixing valve of the present invention;

FIG. 9 is a first cross-sectional view of the assembly of a hydrogen production tank of the present invention;

FIG. 10 is a second cross-sectional view of the assembly of the hydrogen production tank of the present invention;

FIG. 11 is a perspective view of the assembly of a drip tray of the present invention;

FIG. 12 is a first cross-sectional view of the assembly of the drip tray of the present invention;

FIG. 13 is a second cross-sectional view of the assembly of the drip tray of the present invention; and

FIG. 14 is a perspective view of the assembly of a clamping plate driving structure of the present invention.

In the accompanying drawings: 1—chassis, 2—water bottle seat, 3—hydrogen production tank, 4—rotating handle, 5—support frame, 6—handwheel, 7—button, 8—drip tray, 9—clamping plate, 10—filter screen, 11—water outlet pipe, 12—water storage tank, 13—worm wheel, 14—vent pipe, 15—partition, 16—heating tank, 17—slide rod, 18—fixing frame, 19—first spring, 20—sealing block, 21—stop ring, 22—exhaust valve, 23—mixing valve, 24—electrolytic rod, 25—flow control valve, 26—mounting frame, 27—second spring, 28—locking plate, 29—rotating rod, 30—first sliding frame, 31—square post, 32—worm, 33—second sliding frame, 34—sliding post, 35—double—headed screw, 36—third spring, 37—first gear, 38—second gear, and 39—lead screw.

### DETAILED DESCRIPTION

The technical schemes in the embodiments of the present invention are clearly and completely described in the following with reference to the drawings in the embodiments of the present invention. It is obvious that the described embodiments are only some of the embodiments of the present invention and are not all the embodiments thereof. All other embodiments obtained by those of ordinary skill in the art based on the embodiments of the present disclosure without inventive effort fall within the scope of the present disclosure.

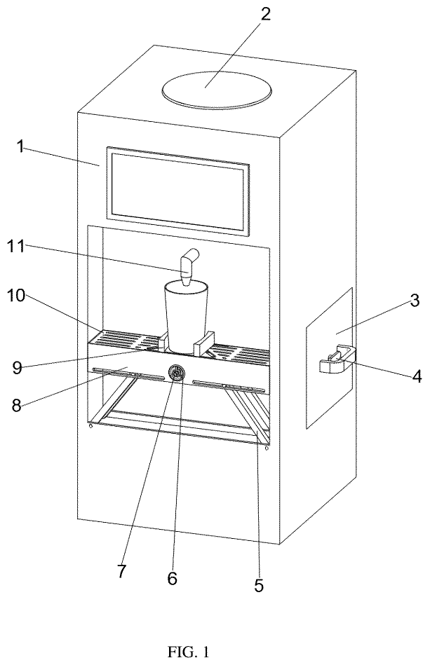

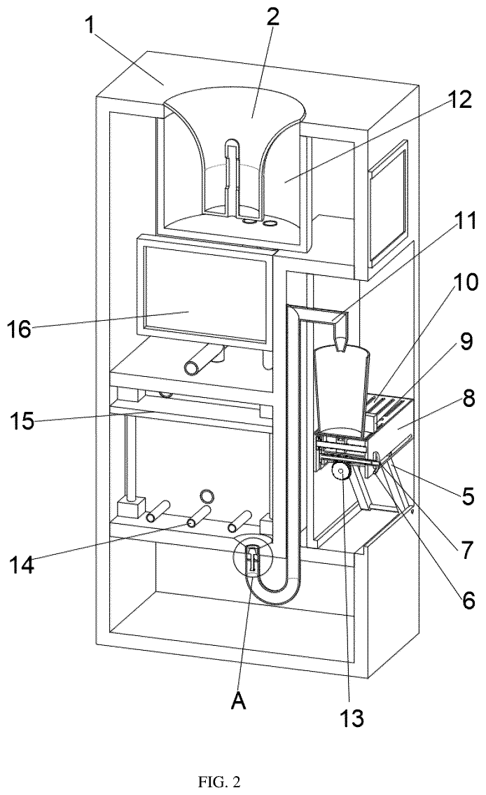

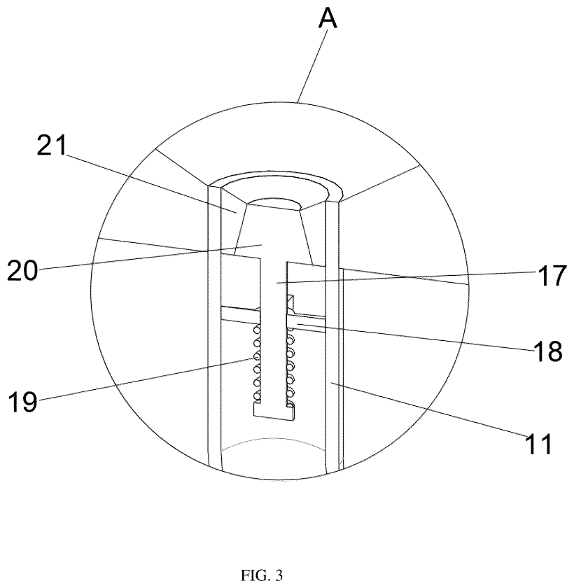

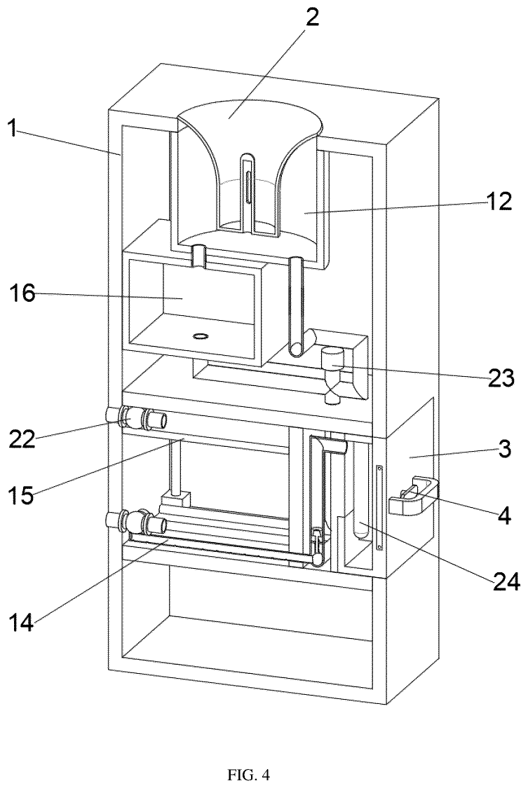

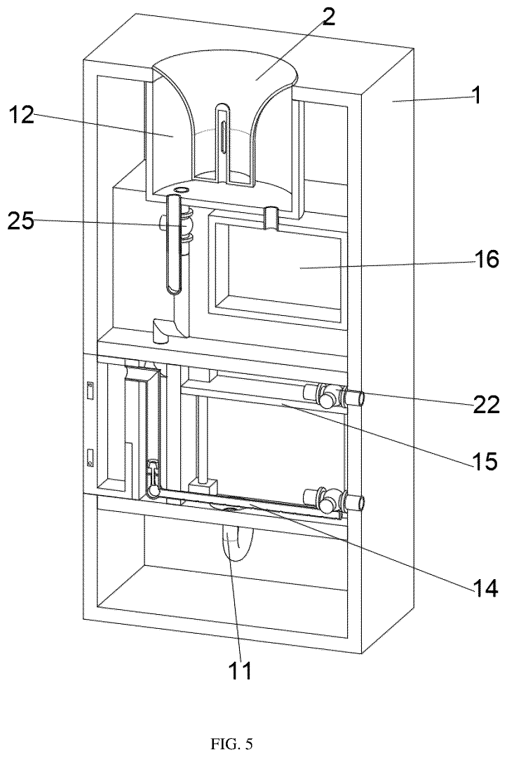

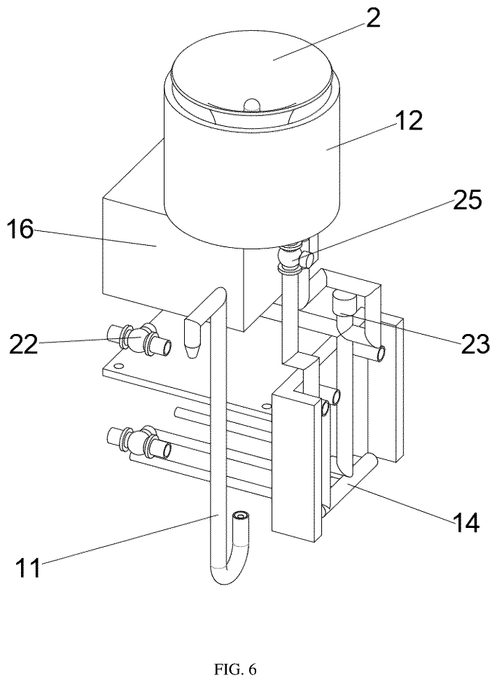

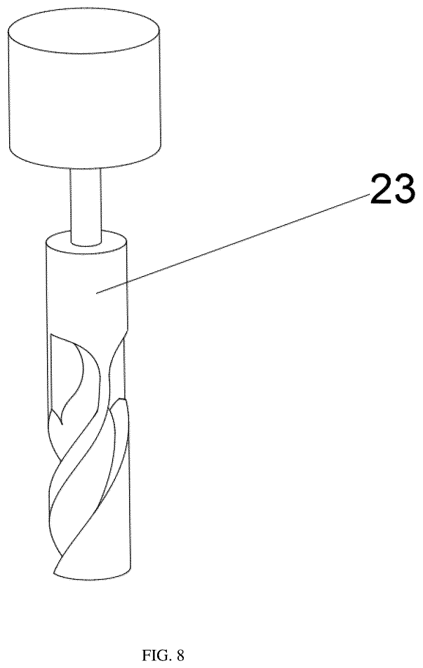

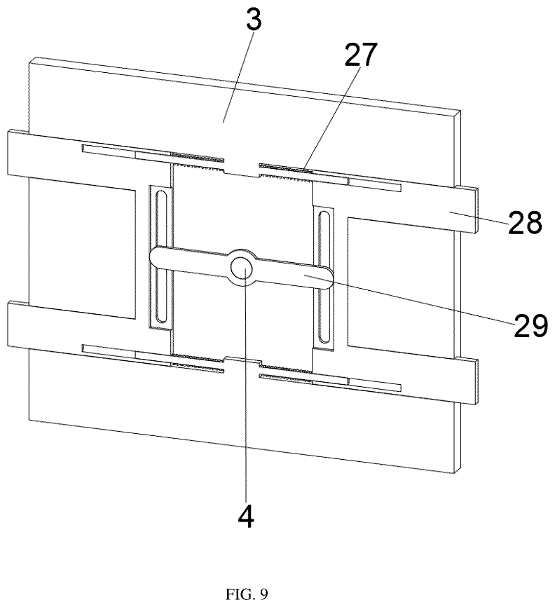

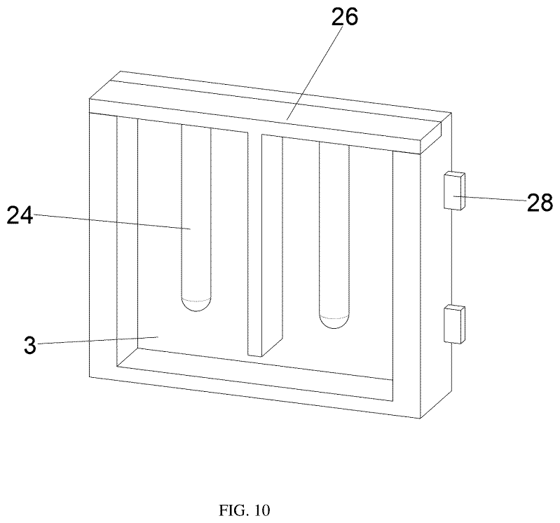

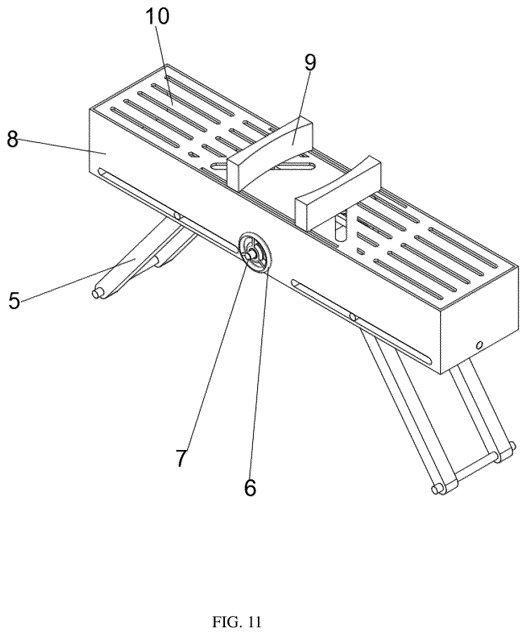

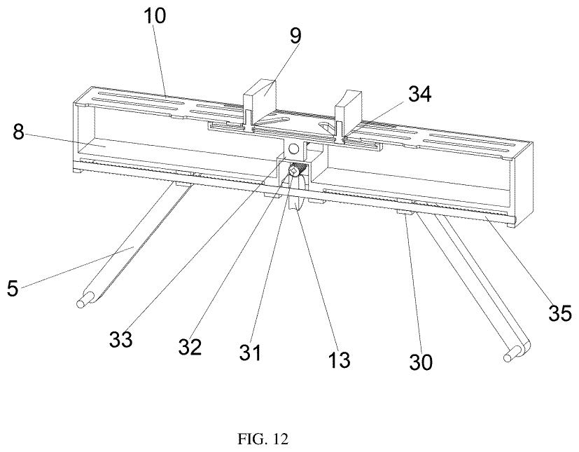

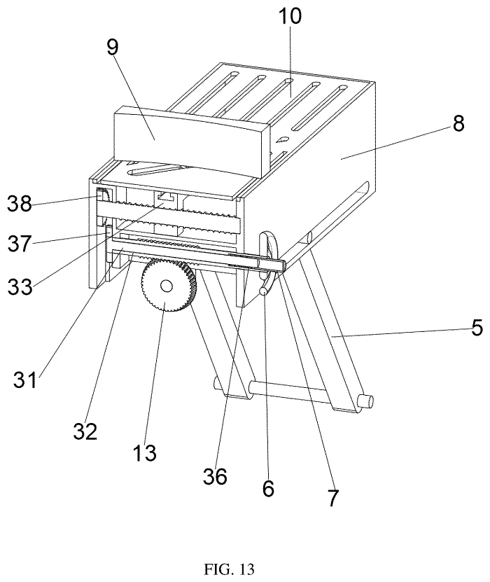

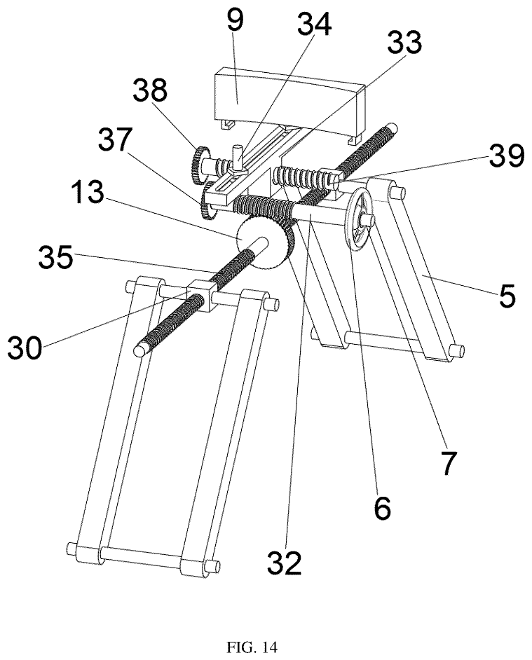

Referring to FIGS. 1-14, the present invention provides the following technical solutions:

A hydrogen-enriched water dispenser is provided, including a chassis 1 and a water storage tank 12 fixed to a top portion of the chassis 1, where a hydrogen production assembly and a hydrogen mixing assembly are provided inside the chassis 1, and a dispensing tray assembly is provided at one side of the chassis 1, where a water outlet pipe 11 penetrates through and is fixed to a bottom portion of the hydrogen mixing assembly, a water outlet end of the water outlet pipe 11 extending above the dispensing tray assembly, and a water bottle seat 2 is fixed inside the water storage tank 12;
the hydrogen production assembly includes a hydrogen production tank 3 and a T-shaped mounting frame 26 installed inside the hydrogen production tank 3, where two sides of a vertical end of the mounting frame 26 are respectively a cathode chamber and an anode chamber, electrolytic rods 24 being installed on the mounting frame 26 in both the cathode chamber and the anode chamber, and bottom ends of the two electrolytic rods 24 being both higher than a bottom end of the mounting frame 26; and
the hydrogen mixing assembly includes a hydrogen mixing chamber disposed inside the chassis 1 and a partition 15 slidably disposed inside the hydrogen mixing chamber, where the hydrogen mixing chamber above the partition 15 is in communication with a top portion of the anode chamber, and a vent pipe 14 is connected between the hydrogen mixing chamber below the partition 15 and a top portion of the cathode chamber, the vent pipe 14 having one end extending to a bottom portion of the hydrogen mixing chamber and the vent pipe 14 having a plurality of through-holes provided at a bottom portion thereof.

A water supply pipe is connected between the water storage tank 12 and the hydrogen production tank 3, the water supply pipe being provided with a flow control valve 25; and a heating tank 16 is fixed inside the chassis 1, where a top portion of the heating tank 16 is in communication with the water storage tank 12, a cold water pipe and a hot water pipe penetrate through and are fixed to the water storage tank 12 and the heating tank 16, respectively, and a water inlet pipe penetrates through and is fixed to one side of the hydrogen mixing chamber below the partition 15, a mixing valve 23 being connected between the water inlet pipe and the cold water pipe and the hot water pipe, where the mixing valve 23 includes a piston symmetrically provided with two water inlet channels, an outer side of the piston being provided with two spiral channels that are in communication with the two water inlet channels, respectively.

Based on the above disclosed structure, when producing hydrogen-enriched water:

A water bottle is inserted into the water bottle seat 2 at the top portion of the chassis 1, allowing water to enter the water storage tank 12 due to gravity. Then, part of the water enters the heating tank 16 for heating. Preferably, a control panel is provided on one side of the chassis 1, where the temperature and volume of the hydrogen-enriched water to be produced can be selected. The mixing valve 23 is then controlled to introduce cold water from the water storage tank 12 and hot water from the heating tank 16 into the water inlet pipe at a set ratio according to the selected temperature. The specific process is as follows. First, the piston of the mixing valve (23) is moved upward to enable communication of two water inlet channels with the cold water pipe and the hot water pipe, respectively. Then, the piston of the mixing valve (23) is rotated according to the desired ratio of cold water to hot water, thereby adjusting the sizes of communication ports between the two water inlet channels and the cold water pipe and hot water pipe, so as to control the water inlet rates of the cold water pipe and hot water pipe, thereby controlling the temperature of the mixed water. At the same time, after entering the two water inlet channels, the cold water and hot water flow into the corresponding communicated spiral channels, causing the cold water and hot water to flow along the spiral channels and thus be discharged from a bottom portion of the piston in a swirling manner. This ensures uniform mixing of cold and hot water to prevent temperature unevenness from affecting dissolution of hydrogen gas. The mixed water is then introduced into the hydrogen mixing chamber below the partition (15), while the flow control valve (25) is opened to feed water from the water storage tank (12) into the hydrogen production tank (3) at a certain rate.

Next, the hydrogen production assembly is powered on and started, allowing the electrolytic rods 24 in the anode chamber and the cathode chamber to be in communication with the positive and negative electrodes, respectively. Since the bottom ends of the two electrolytic rods 24 are both higher than the bottom end of the mounting frame 26, the mounting frame 26 separates the top portions of the anode chamber and the cathode chamber during water electrolysis, preventing the mixing of hydrogen gas and oxygen gas. Oxygen gas is produced on the surface of the electrolytic rod 24 in the anode chamber, and then diffuses into the hydrogen mixing chamber above the partition 15, while hydrogen gas produced on the surface of the electrolytic rod 24 in the cathode chamber enters the vent pipe 14 and is then discharged from the through-hole at the bottom portion of the vent pipe 14. After water is added to the hydrogen mixing chamber, the bottom end of the vent pipe 14 is submerged, causing the hydrogen gas discharged from the through-hole at the bottom end of the vent pipe 14 to be discharged in the form of bubbles. The hydrogen gas bubbles can increase the contact area between hydrogen gas and water, thereby increasing the dissolution rate. The gas pressure within the hydrogen mixing chamber below the partition 15 then gradually rises. When the gas pressure within the hydrogen mixing chamber below the partition 15 reaches the set value, i.e., a gas pressure that is sufficient to expel the hydrogen-enriched water from the mixing chamber through the water outlet pipe 11, the hydrogen production assembly continues to electrolyze water, allowing hydrogen gas to continue to enter, thereby gradually expelling the hydrogen-enriched water through the water outlet pipe 11, which is collected at the dispensing tray assembly located below the water outlet end of the water outlet pipe 11.

During expulsion of hydrogen-enriched water, the volume of liquid within the hydrogen mixing chamber gradually decreases while the volume of gas gradually increases. When the amount of hydrogen-enriched water is small, the oxygen gas above the partition 15 and the hydrogen gas below the partition 15 can reach gas pressure equilibrium, causing the partition 15 to move downward as the hydrogen-enriched water continues to be expelled. This can increase the volume occupied by the oxygen gas above the partition 15, thereby reducing the amount of water that needs to be electrolyzed in order to maintain the gas pressure produced by hydrogen gas in the hydrogen mixing chamber below the partition at the set gas pressure value, thus reducing the consumption of water electrolyzed while simultaneously improving the efficiency of production and expulsion of hydrogen-enriched water.

Similarly, when producing a small amount of hydrogen-enriched water, during introduction and mixing of hydrogen gas, the hydrogen gas below the partition 15 and the oxygen gas above the partition 15 achieve gas pressure equilibrium, allowing some oxygen gas to replace hydrogen gas in occupying part of the space within the hydrogen mixing chamber, thereby reducing the amount of hydrogen gas used, further reducing the amount of water electrolyzed, and improving production efficiency. This enables the production of any amount of hydrogen-enriched water with low consumption and high efficiency.

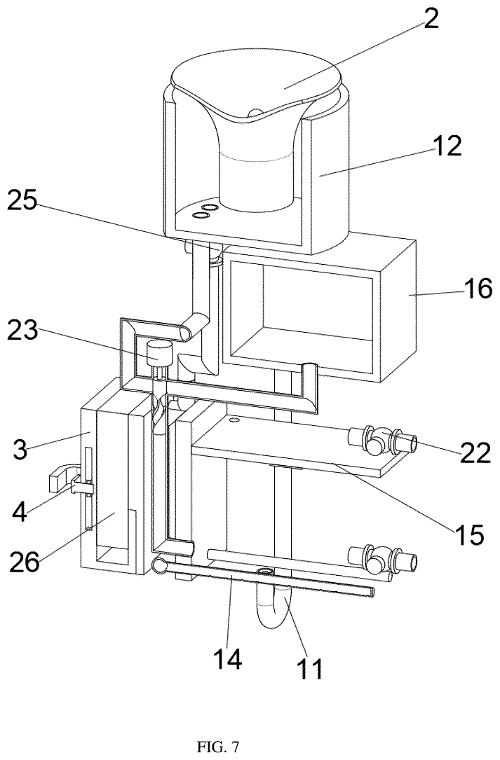

Additionally, two exhaust valves 22 penetrate through and are fixed to one side of the chassis 1, where the two exhaust valves 22 are both in communication with the hydrogen mixing chamber, and the two exhaust valves 22 are respectively located on an upper side and a lower side of the partition 15. Based on this, after completing the introduction and production of hydrogen-enriched water, the two exhaust valves (22) are opened to allow the gas pressure within the hydrogen mixing chamber to gradually return to the same gas pressure value as the external environment. This can reserve a partial gas pressure difference for introduction of hydrogen gas during the next hydrogen mixing operation, thereby ensuring the operation effectiveness of hydrogen mixing. Preferably, as shown in FIG. 7, the exhaust valve 22 located below the partition 15 is positioned at a lower location, and since the density of hydrogen gas is lower than that of air, after the reduction of gas pressure, the hydrogen mixing chamber below the partition 15 remains predominantly filled with hydrogen gas, thereby reducing interference from other gases on dissolution of hydrogen gas in water during subsequent use.

Furthermore, the water outlet pipe 11 and the vent pipe 14 are each provided with a check valve assembly, the check valve assembly including a fixing frame 18 and a stop ring 21 that are fixed to an inner wall of the water outlet pipe 11 or the vent pipe 14, where a slide rod 17 slidably penetrates through the fixing frame 18, a first spring 19 being fixedly connected between a bottom end of the slide rod 17 and the fixing frame 18, and a sealing block 20 in a truncated cone structure being fixed to a top portion of the slide rod 17, where an outer wall of the sealing block 20 is slidably engaged with an inner wall of the stop ring 21. Based on this, the check valve in the water outlet pipe 11 prevents hydrogen-enriched water in the hydrogen mixing chamber from entering the hydrogen production tank 3, while the check valve in the vent pipe 14 prevents external air and liquids from entering and contaminating the interior of the hydrogen mixing chamber. The specific working process of the check valve is as follows: When the gas pressure in the cathode chamber or hydrogen mixing chamber reaches a certain value, the gas or liquid pushes the sealing block 20 from the top portion, causing the sealing block 20 to separate from the stop ring 21, thus creating a gap for passage of gas or liquid. At the same time, the sealing block 20 pushes the slide rod 17 downward to stretch the first spring 19. After the gas or liquid passes through, under the elastic force of the first spring 19, the slide rod 17 moves upward, causing the outer wall of the sealing block 20 to tightly fit against the inner wall of the stop ring 21, thereby preventing liquid or gas from passing upward from the bottom portion. Furthermore, the elasticity of the first spring (19) in the check valve within the water outlet pipe (11) can adjust the set gas pressure value within the hydrogen mixing chamber, causing the gas pressure value within the hydrogen mixing chamber to favor dissolution of hydrogen gas, thereby improving the quality of hydrogen-enriched water.

Additionally, after prolonged use of the electrolytic rod 24 in the anode chamber, impurities in water adhere to its surface, affecting contact between water and the electrolytic rod 24 and consequently reducing the electrolysis rate. Preferably, two locking plates 28 are symmetrically and slidably connected inside the hydrogen production tank 3, and a rotating handle 4 is rotatably connected at one side of the hydrogen production tank 3, where a rotating rod 29 is fixedly connected at one end of the rotating handle 4, a sliding shaft being fixedly installed at each of two ends of the rotating rod 29, and a sliding groove being provided at one side of each of the two locking plates 28, and the two sliding shafts being respectively slidably engaged within the two sliding grooves, a plurality of second springs 27 are fixedly connected between the two locking plates 28 and a middle portion of the hydrogen production tank 3, and a plurality of locking grooves slidably engaged with the two locking plates 28 are formed on the chassis 1. Based on this, during disassembly of the hydrogen production tank 3, rotating the rotating handle 4 drives the rotating rod 29 to rotate. The sliding shafts driven by the rotating rod 29 move toward the middle portion, and the sliding shafts drive the two locking plates 28 to move toward the middle portion via the sliding grooves on the locking plates 28. This causes the end portions of the two locking plates 28 to disengage from the locking grooves on the chassis 1, while the two locking plates 28 compress the plurality of second springs 27. At this time, pulling the hydrogen production tank 3 allows the hydrogen production tank 3 to be extracted from the chassis 1, facilitating replacement of the electrolytic rods 24 on the mounting frame 26 inside the hydrogen production tank 3. This ensures electrolytic hydrogen production efficiency, thereby ensuring the production efficiency of hydrogen-enriched water. Additionally, during installation of the hydrogen production tank 3, rotating the rotating handle 4 causes the rotating rod 29 to retract the two locking plates 28 into the hydrogen production tank 3. The hydrogen production tank 3 is then inserted into the chassis 1. When the end portions of the two locking plates 28 move to the locking grooves inside the chassis 1, the end portions of the locking plates 28 extend into the locking grooves under the elastic force of the second springs 27, thereby completing the installation of the hydrogen production tank 3, which is simple to operate.

As described above, regarding the dispensing tray assembly, the following structures are preferably provided.

The dispensing tray assembly includes a drip tray 8 slidably connected inside the chassis 1 and a filter screen 10 fixed on the drip tray 8, two clamping plates 9 for clamping a cup being symmetrically and slidably connected to a top portion of the filter screen 10.

Two support frames 5 are symmetrically and rotatably connected to the chassis 1, top ends of the two support frames 5 being both slidably connected to a bottom portion of the drip tray 8, and the top ends of the two support frames 5 being both rotatably connected with first sliding frames 30, a worm 32 rotatably penetrates through one side of the drip tray 8, and a double-headed screw 35 is rotatably connected to the bottom portion of the drip tray 8, where the two first sliding frames 30 are respectively threadedly connected to two ends of the double-headed screw 35, and a worm wheel 13 is coaxially fixed on the double-headed screw 35, the worm wheel 13 being in meshed connection with the worm 32.

A lead screw 39 is rotatably connected within the drip tray 8, the lead screw 39 being threadedly connected with a second sliding frame 33 and second sliding frame 33 being slidably connected to the drip tray 8, two sliding posts 34 are slidably connected to a top portion of the second sliding frame 33, guide grooves respectively slidably engaged with the two sliding posts 34 are formed on the filter screen 10 and the two guide grooves are provided to be inclined, and recesses are respectively formed on bottom portions of the two clamping plates 9, the two sliding posts 34 respectively extending slidably into the two recesses.

One end of the worm 32 is fixedly connected with a handwheel 6, and a square post 31 is slidably connected inside the worm 32, where a first gear 37 and a second gear 38 are respectively coaxially fixed at one end of the square post 31 and one end of the lead screw 39, and a button 7 is fixedly connected to the other end of the square post 31, a third spring 36 being fixedly connected between the button 7 and the worm 32.

As can be seen, during dispensing tray, a cup is first placed between the two clamping plates 9. Then, the button 7 is pressed to compress the third spring 36, and at the same time, the button 7 drives the first gear 37 to move toward the rear side through the square post 31, causing the first gear 37 to move below the second gear 38 and engage the first gear 37 with the second gear 38. At this time, rotating the handwheel 6 drives the worm 32 to rotate, enabling the worm 32 to drive the square post 31 to rotate. Then, through the transmission of the first gear 37 and the second gear 38, the second gear 38 drives the lead screw 39 to rotate, causing the threadedly connected second sliding frame 33 to move rearward along the lead screw 39, such that the second sliding frame 33 drives the two sliding posts 34 to move toward the rear side. Simultaneously, the two sliding posts 34 slide along the tilted guide grooves on the filter screen 10, such that the two sliding posts 34 move laterally toward the middle portion. Through the recesses at the bottom portions of the clamping plates 9, the two clamping plates 9 move toward the middle portion at the top portion of the filter screen 10, thereby causing the two clamping plates 9 to clamp the cup.

After clamping the cup, releasing the button 7 allows the elastic force of the third spring 36 to retract the button 7. Simultaneously, the first gear 37 is driven by the square post 31 to move forward, disengaging the first gear 37 from the second gear 38. At this time, further rotating the handwheel 6 drives the worm 32 to rotate. Through the transmission of the worm 32 and the worm wheel 13, the worm wheel 13 drives the double-headed screw 35 to rotate, causing the two first sliding frames 30 threadedly connected to the two ends of the double-headed screw 35 to slide outward. This causes the two support frames 5 to rotate outward about the axis on the chassis 1, such that the two support frames 5 push the drip tray 8 to move upward and thus lift the clamped cup to move upward until the mouth of the cup aligns with the water outlet end of the water outlet pipe 11, so as to prevent splashing of hydrogen-enriched water and reduce the flow distance of hydrogen-enriched water, thereby ensuring the hydrogen content of the hydrogen-enriched water.

Additionally, during the above process, when the worm 32 is rotated to cause the two clamping plates 9 to clamp the cup, the rotation of the worm 32 simultaneously raises the drip tray 8. If the initial position of the cup is too high, the worm 32 can be rotated reversely to lower the drip tray 8, thereby facilitating the clamping operation of the cup. Furthermore, the drip tray 8 and the filter screen 10 function to collect and filter wastewater.

Although the embodiments of the present invention have been shown and described, it can be understood by those of ordinary skill in the art that various changes, modifications, substitutions, and variations may be made to these embodiments without departing from the principles and concepts of the present invention, and the scope of the present invention is defined by the appended claims and their equivalents.

1. A hydrogen-enriched water dispenser, comprising a chassis (1) and a water storage tank (12) fixed to a top portion of the chassis (1), wherein a hydrogen production assembly and a hydrogen mixing assembly are provided inside the chassis (1), and a dispensing tray assembly is provided at one side of the chassis (1), wherein a water outlet pipe (11) penetrates through and is fixed to a bottom portion of the hydrogen mixing assembly, a water outlet end of the water outlet pipe (11) extending above the dispensing tray assembly, and a water bottle seat (2) is fixed inside the water storage tank (12);
the hydrogen production assembly comprises a hydrogen production tank (3) and a T-shaped mounting frame (26) installed inside the hydrogen production tank (3), wherein two sides of a vertical end of the mounting frame (26) are respectively a cathode chamber and an anode chamber, electrolytic rods (24) being installed on the mounting frame (26) in both the cathode chamber and the anode chamber, and bottom ends of the two electrolytic rods (24) being both higher than a bottom end of the mounting frame (26); and
the hydrogen mixing assembly comprises a hydrogen mixing chamber disposed inside the chassis (1) and a partition (15) slidably disposed inside the hydrogen mixing chamber, wherein the hydrogen mixing chamber above the partition (15) is in communication with a top portion of the anode chamber, and a vent pipe (14) is connected between the hydrogen mixing chamber below the partition (15) and a top portion of the cathode chamber, the vent pipe (14) having one end extending to a bottom portion of the hydrogen mixing chamber and the vent pipe (14) having a plurality of through-holes provided at a bottom portion thereof.

2. The hydrogen-enriched water dispenser of claim 1, wherein a water supply pipe is connected between the water storage tank (12) and the hydrogen production tank (3), the water supply pipe being provided with a flow control valve (25).

3. The hydrogen-enriched water dispenser of claim 1, wherein a heating tank (16) is fixed inside the chassis (1), wherein a top portion of the heating tank (16) is in communication with the water storage tank (12), a cold water pipe and a hot water pipe penetrate through and are fixed to the water storage tank (12) and the heating tank (16), respectively, and a water inlet pipe penetrates through and is fixed to one side of the hydrogen mixing chamber below the partition (15), a mixing valve (23) being connected between the water inlet pipe and the cold water pipe and the hot water pipe, wherein the mixing valve (23) comprises a piston symmetrically provided with two water inlet channels, an outer side of the piston being provided with two spiral channels that are in communication with the two water inlet channels, respectively.

4. The hydrogen-enriched water dispenser of claim 1, wherein two exhaust valves (22) penetrate through and are fixed to one side of the chassis (1), wherein the two exhaust valves (22) are both in communication with the hydrogen mixing chamber, and the two exhaust valves (22) are respectively located on an upper side and a lower side of the partition (15).

5. The hydrogen-enriched water dispenser of claim 1, wherein the water outlet pipe (11) and the vent pipe (14) are each provided with a check valve assembly, the check valve assembly comprising a fixing frame (18) and a stop ring (21) that are fixed to an inner wall of the water outlet pipe (11) or the vent pipe (14), wherein a slide rod (17) slidably penetrates through the fixing frame (18), a first spring (19) being fixedly connected between a bottom end of the slide rod (17) and the fixing frame (18), and a sealing block (20) in a truncated cone structure being fixed to a top portion of the slide rod (17), wherein an outer wall of the sealing block (20) is slidably engaged with an inner wall of the stop ring (21).

6. The hydrogen-enriched water dispenser of claim 1, wherein two locking plates (28) are symmetrically and slidably connected inside the hydrogen production tank (3), and a rotating handle (4) is rotatably connected at one side of the hydrogen production tank (3), wherein a rotating rod (29) is fixedly connected at one end of the rotating handle (4), a sliding shaft being fixedly installed at each of two ends of the rotating rod (29), and a sliding groove being provided at one side of each of the two locking plates (28), and the two sliding shafts being respectively slidably engaged within the two sliding grooves, a plurality of second springs (27) are fixedly connected between the two locking plates (28) and a middle portion of the hydrogen production tank (3), and a plurality of locking grooves slidably engaged with the two locking plates (28) are formed on the chassis (1).

7. The hydrogen-enriched water dispenser of claim 1, wherein the dispensing tray assembly comprises a drip tray (8) slidably connected inside the chassis (1) and a filter screen (10) fixed on the drip tray (8), two clamping plates (9) for clamping a cup being symmetrically and slidably connected to a top portion of the filter screen (10).

8. The hydrogen-enriched water dispenser of claim 7, wherein two support frames (5) are symmetrically and rotatably connected to the chassis (1), top ends of the two support frames (5) being both slidably connected to a bottom portion of the drip tray (8), and the top ends of the two support frames (5) being both rotatably connected with first sliding frames (30), a worm (32) rotatably penetrates through one side of the drip tray (8), and a double-headed screw (35) is rotatably connected to the bottom portion of the drip tray (8), wherein the two first sliding frames (30) are respectively threadedly connected to two ends of the double-headed screw (35), and a worm wheel (13) is coaxially fixed on the double-headed screw (35), the worm wheel (13) being in meshed connection with the worm (32).

9. The hydrogen-enriched water dispenser of claim 8, wherein a lead screw (39) is rotatably connected within the drip tray (8), the lead screw (39) being threadedly connected with a second sliding frame (33) and second sliding frame (33) being slidably connected to the drip tray (8), two sliding posts (34) are slidably connected to a top portion of the second sliding frame (33), guide grooves respectively slidably engaged with the two sliding posts (34) are formed on the filter screen (10) and the two guide grooves are provided to be inclined, and recesses are respectively formed on bottom portions of the two clamping plates (9), the two sliding posts (34) respectively extending slidably into the two recesses.

10. The hydrogen-enriched water dispenser of claim 9, wherein one end of the worm (32) is fixedly connected with a handwheel (6), and a square post (31) is slidably connected inside the worm (32), wherein a first gear (37) and a second gear (38) are respectively coaxially fixed at one end of the square post (31) and one end of the lead screw (39), and a button (7) is fixedly connected to the other end of the square post (31), a third spring (36) being fixedly connected between the button (7) and the worm (32).
